(19) United States
(12) Patent Application Publication
(10) Pub. No.: US 2006/0265536 A1
(43) Pub. Date: Nov. 23, 2006

(54) User-defined interrupt signal handling method and system

(75) Inventor: Chih-Wei Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/133,516

(22) Filed: May 19, 2005

(51) Int. Cl. G06F 13/24

(52) U.S. Cl. 710/269

(57) ABSTRACT

A user-defined interrupt signal handling method and system is proposed, which is designed for use with a computer platform equipped with a programmable interrupt controller for providing a user-defined interrupt signal handling function, and which is characterized by the provision of an interrupt configuration table which defines a virtual device corresponding to each user-defined interrupt signal from one peripheral device as well as the system interrupt line IRQ corresponding to the virtual device. This feature allows the implementation of a user-defined interrupt signal handling function in ACPI mode without having to use expensive PCI controllers, and thus allows the implementation to be more cost-effective than prior art.

### BACKGROUND OF THE INVENTION

1. Field of the Invention

This invention relates to computer hardware technology, and more particularly, to a user-defined interrupt signal handling method and system which is designed for use in conjunction with a computer platform equipped with a programmable interrupt controller for providing a user-defined interrupt signal handling function for handling user-defined interrupt signals that are issued by peripheral devices connected to the computer platform.

2. Description of Related Art

Computer systems typically utilize interrupt signals for peripheral devices, such as hard disk drives, keyboards, and mouse devices, to request the CPU (Central Processing Unit) to temporarily halt its current operation and execute related interrupt handling programs to handle requests from the peripheral devices for the peripheral devices to exchange data with the CPU.

PIC (Programmable Interrupt Controller) is a PC hardware architecture developed by the Intel Corporation of USA that allows the user to define a set of interrupt signals for use by the peripheral devices connected to a computer system. In addition, APIC (Advanced Programmable Interrupt Controller) is an advanced type of PIC that is specifically designed for use on multi-processor based computer systems, such as network servers, to offer a multiplexed interrupt control function.

In practical application, in order to allow a computer system to operate in PIC mode, it is required to connect a specified system interrupt line IRQ to a PCI (Peripheral Component Interconnect) controller. When the PCI controller receives a user-defined interrupt signal from a connected peripheral device, the PCI controller will responsively issue a corresponding PCI interrupt signal to the CPU, which causes the CPU to execute the peripheral device's driver program. On the other hand, when the computer system operates in APIC mode, the required interrupt configurations should be predefined in the MP (Multi-Processor) table or ACPI (Advanced Configuration and Power Interface) table in the BIOS (Basic Input/Output System) of the computer system.

One drawback to the above-mentioned ACPI mode of operation, however, is that in order to define the required interrupt configurations in the MP or ACPI table in the BIOS, the computer system should be preinstalled with a hardware PCI controller, and since a hardware PCI controller is typically costly to purchase, it would cause the implementation to be less cost-effective.

### SUMMARY OF THE INVENTION

It is therefore an objective of this invention to provide a user-defined interrupt signal handling method and system which can implement a user-defined interrupt signal handling function in ACPI mode without having to use expensive PCI controllers.

The user-defined interrupt signal handling method and system according to the invention is designed for use in conjunction with a computer platform equipped with a programmable interrupt controller for providing a user-defined interrupt signal handling function for handling user-defined interrupt signals that are issued by peripheral devices connected to the computer platform.

In terms of method, the invention comprises: (1) building a interrupt configuration table for defining a virtual device for the peripheral device and a specified system interrupt line corresponding to the user-defined interrupt signal issued by the peripheral device; (2) in actual operation, responding to each user-defined interrupt signal issued by the peripheral device by issuing an interrupt processing enable message; (3) responding to the interrupt processing enable message by consulting the interrupt configuration table to find out which system interrupt line is associated with the user-defined interrupt signal issued by the peripheral device; and (4) activating a driver program associated with the peripheral device issuing the user-defined interrupt signal via the system interrupt line specified by the interrupt signal processing module to thereby allow the activated driver program to be executed via the system interrupt line to handle the request from the peripheral device issuing the user-defined interrupt signal.

In terms of system, the invention comprises: (a) an interrupt signal responding module, which is capable of listening to each user-defined interrupt signal issued by the peripheral device and responsively issuing an interrupt processing enable message; (b) an interrupt signal processing module, which is included with an interrupt configuration table for defining a virtual device for the peripheral device and a specified system interrupt line corresponding to the user-defined interrupt signal issued by the peripheral device, and which is capable of listening to each interrupt processing enable message issued by the peripheral device and responsively consulting the interrupt configuration table to find out which system interrupt line is associated with the user-defined interrupt signal issued by the peripheral device; and (c) a driver program activating module, which is capable of activating a driver program associated with the peripheral device issuing the user-defined interrupt signal via the system interrupt line specified by the interrupt signal processing module to thereby allow the activated driver program to be executed via the system interrupt line to handle the request from the peripheral device issuing the user-defined interrupt signal.

The user-defined interrupt signal handling method and system according to the invention is characterized by the provision of an interrupt configuration table which defines a virtual device corresponding to each user-defined interrupt signal from one peripheral device as well as the system interrupt line IRQ corresponding to the virtual device. This feature allows the implementation of a user-defined interrupt signal handling function in ACPI mode without having to use expensive PCI controllers, and thus allows the invention to be more cost-effective to implement than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and modularized object-oriented component model of the user-defined interrupt signal handling system according to the invention; and

FIG. 2 is a table showing an example of the interrupt configuration table utilized by the user-defined interrupt signal handling system according to the invention.

### DETAILED DESCRIPTION OF PREFERRED EMBODIMENTS

The user-defined interrupt signal handling method and system according to the invention is disclosed in full details by way of preferred embodiments in the following with reference to the accompanying drawings.

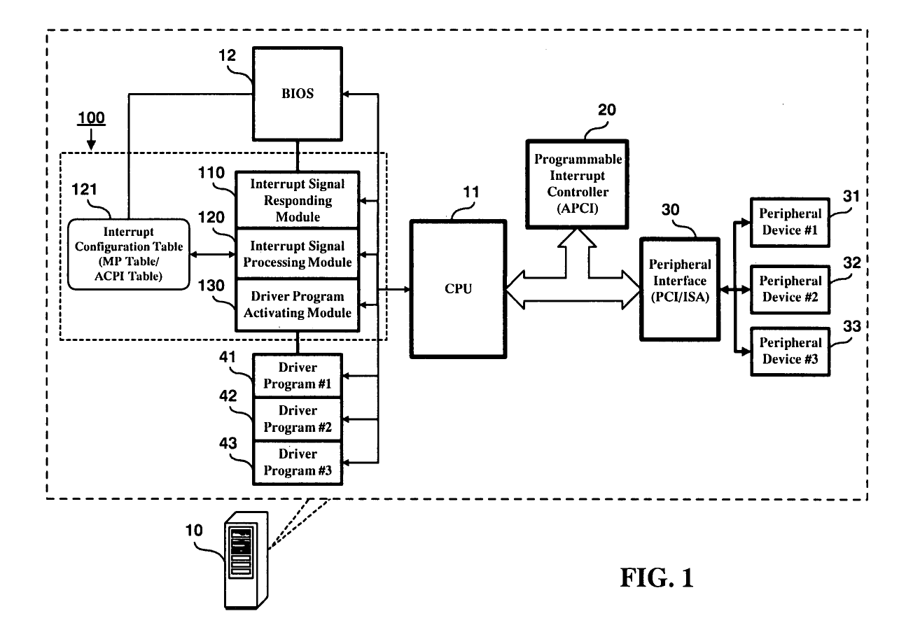

FIG. 1 is a schematic diagram showing the application architecture and modularized object-oriented component model of the user-defined interrupt signal handling system according to the invention (as the part enclosed in the dotted box indicated by the reference numeral 100). As shown, the user-defined interrupt signal handling system of the invention 100 is designed for use in conjunction with a computer platform 10, particularly a multi-processor based computer platform (such as a network server), that is equipped with a programmable interrupt controller 20, such as an APIC (Advanced Programmable Interrupt Controller), and a peripheral interface 30 for connection with one or more peripheral devices (in the embodiment of FIG. 1, for example, 3 peripheral devices 31, 32, 33 are connected; but in practice, the number of peripheral devices is unrestricted). These peripheral devices 31, 32, 33 can be PCI (Peripheral Component Interconnect) compliant or ISA (Industry Standard Architecture) compliant peripheral devices, including external hard disk modules, external CD/DVD modules, keyboard, mouse, and so on.

In actual operation, the user-defined interrupt signal handling system of the invention 100 is capable of providing a user-defined interrupt signal handling function for each user-defined interrupt signal issued by any one of the peripheral devices 31, 32, 33 connected to the computer platform 10 for the purpose of finding out the system interrupt line IRQ (Interrupt ReQuest) that is associated with the user-defined interrupt signal so as to allow the CPU (Central Processing Unit) 11 of the computer platform 10 to execute the driver programs 41, 42, 43 associated with the peripheral devices 31, 32, 33, i.e., if the peripheral device 31 issues a user-defined interrupt signal, the driver program 41 is executed; if the peripheral device 32 issues a user-defined interrupt signal, the driver program 42 is executed; and if the peripheral device 33 issues a user-defined interrupt signal, the driver program 43 is executed.

As shown in FIG. 1, the modularized object-oriented component model of the user-defined interrupt signal handling system of the invention 100 comprises: (a) an interrupt signal responding module 110; (b) an interrupt signal processing module 120; and (c) a driver program activating module 130. In practical implementation, for example, the user-defined interrupt signal handling system of the invention 100 can be entirely realized as computer code and integrate the computer code as an add-on module to the operating system of the computer platform 10, so as to be executed by the CPU 11 of the computer platform 10 to provide the desired user-defined interrupt signal handling function.

The interrupt signal responding module 110 is capable of listening to each user-defined interrupt signal issued by any one of the peripheral devices 31, 32, 33 and responsively issuing an interrupt processing enable message to the interrupt signal processing module 120.

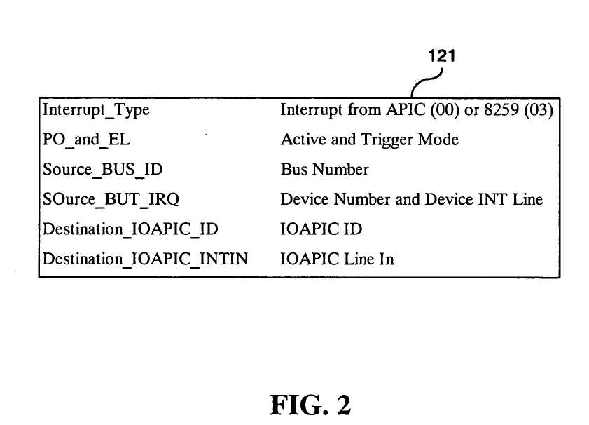

The interrupt signal processing module 120 includes an interrupt configuration table 121 which predefines a virtual device corresponding to each of the peripheral devices 31, 32, 33 as well as a mapping relationship for mapping each user-defined interrupt signal issued by the peripheral devices 31, 32, 33 to a specified system interrupt line IRQ. In actual operation, the interrupt signal processing module 120 is capable of being activated in response to the interrupt processing enable message from the interrupt signal responding module 110 to thereupon consult the interrupt configuration table 121 to find out which system interrupt line IRQ is associated with the currently received user-defined interrupt signal issued by one of the peripheral devices 31, 32, 33 corresponding to the virtual device defined in the interrupt configuration table 121. In practical implementation, for instance, the interrupt configuration table 121 is integrated to an MP (Multi-Processor) table or ACPI (Advanced Configuration and Power Interface) table in the BIOS 12 of the computer platform 10. FIG. 2 shows an example of the interrupt configuration table 121.

The driver program activating module 130 is capable of activating a driver program (41, 42, or 43) associated with the peripheral device (31, 32, or 33) issuing the user-defined interrupt signal by means of the system interrupt line IRQ specified by the interrupt signal processing module 120 to thereby allow the activated driver program (41, 42, or 43) to be executed via the system interrupt line IRQ to handle the request from the peripheral device (31, 32, or 33) issuing the user-defined interrupt signal.

In the following description of a practical application, it is assumed that the peripheral device 31 is an external hard disk module, and which is connected by means of hot plugging to the computer platform 10 and thus causes the generation of a user-defined interrupt signal.

In the foregoing case, the user-defined interrupt signal issued by the peripheral device 31 is first transferred by the peripheral interface 30 to the programmable interrupt controller 20. This action will activate the interrupt signal responding module 110 in the user-defined interrupt signal handling system of the invention 100 to respond to the user-defined interrupt signal by issuing an interrupt processing enable message to the interrupt signal processing module 120. In response, the interrupt signal processing module 120 consults the interrupt configuration table 121 to find which system interrupt line IRQ corresponds to the currently received user-defined interrupt signal issued by the peripheral device 31, i.e., by first finding the virtual device that corresponds to the peripheral device 31 and then the system interrupt line IRQ that corresponds to the virtual device. Subsequently, the driver program activating module 130 utilizes the system interrupt line IRQ to activate the driver program 41 associated with the peripheral device 31 issuing the user-defined interrupt signal. This allows the CPU 11 to execute the driver program 41 to handle the request from the peripheral device 31 issuing the user-defined interrupt signal.

In conclusion, the invention provides a user-defined interrupt signal handling method and system for use in conjunction with a computer platform equipped with a programmable interrupt controller for providing a user-defined interrupt signal handling function, and which is characterized by the provision of an interrupt configuration table which defines a virtual device corresponding to each user-defined interrupt signal from one peripheral device as well as the system interrupt line IRQ corresponding to the virtual device. This feature allows the implementation of a user-defined interrupt signal handling function in ACPI mode without having to use expensive PCI controllers, and thus allows the invention to be more cost-effective to implement than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A user-defined interrupt signal handling method for use on a computer platform equipped with a programmable interrupt controller and at least one peripheral device for providing a user-defined interrupt signal handling function for each user-defined interrupt signal issued by the peripheral device;
the user-defined interrupt signal handling method comprising:
building a interrupt configuration table for defining a virtual device for the peripheral device and a specified system interrupt line corresponding to the user-defined interrupt signal issued by the peripheral device;
in actual operation,
responding to each user-defined interrupt signal issued by the peripheral device by issuing an interrupt processing enable message;
responding to the interrupt processing enable message by consulting the interrupt configuration table to find out which system interrupt line is associated with the user-defined interrupt signal issued by the peripheral device; and
activating a driver program associated with the peripheral device issuing the user-defined interrupt signal via the system interrupt line specified by the interrupt signal processing module to thereby allow the activated driver program to be executed via the system interrupt line to handle the request from the peripheral device issuing the user-defined interrupt signal.

2. The user-defined interrupt signal handling method of claim 1, wherein the interrupt configuration table is integrated to a Multi-Processor (MP) table in the BIOS (Basic Input/Output System) of the computer platform.

3. The user-defined interrupt signal handling method of claim 1, wherein the interrupt configuration table is integrated to an ACPI (Advanced Configuration and power Interface) table in the BIOS (Basic Input/Output System) of the computer platform.

4. The user-defined interrupt signal handling method of claim 1, wherein the peripheral device is a PCI (Peripheral Component Interconnect) compliant peripheral device.

5. The user-defined interrupt signal handling method of claim 1, wherein the peripheral device is an ISA (Industry Standard Architecture) compliant peripheral device.

6. A user-defined interrupt signal handling system for use with a computer platform equipped with a programmable interrupt controller and at least one peripheral device for providing a user-defined interrupt signal handling function for each user-defined interrupt signal issued by the peripheral device;
the user-defined interrupt signal handling system comprising:
an interrupt signal responding module, which is capable of listening to each user-defined interrupt signal issued by the peripheral device and responsively issuing an interrupt processing enable message;
an interrupt signal processing module, which is included with an interrupt configuration table for defining a virtual device for the peripheral device and a specified system interrupt line corresponding to the user-defined interrupt signal issued by the peripheral device, and which is capable of being activated in response to each interrupt processing enable message from the interrupt signal responding module to thereupon consult the interrupt configuration table to find out which system interrupt line is associated with the user-defined interrupt signal issued by the peripheral device; and
a driver program activating module, which is capable of activating a driver program associated with the peripheral device issuing the user-defined interrupt signal via the system interrupt line specified by the interrupt signal processing module to thereby allow the activated driver program to be executed via the system interrupt line to handle the request from the peripheral device issuing the user-defined interrupt signal.

7. The user-defined interrupt signal handling system of claim 6, wherein the interrupt configuration table is integrated to a Multi-Processor (MP) table in the BIOS (Basic Input/Output System) of the computer platform.

8. The user-defined interrupt signal handling system of claim 6, wherein the interrupt configuration table is integrated to an ACPI (Advanced Configuration and power Interface) table in the BIOS (Basic Input/Output System) of the computer platform.

9. The user-defined interrupt signal handling system of claim 6, wherein the peripheral device is a PCI (Peripheral Component Interconnect) compliant peripheral device.

10. The user-defined interrupt signal handling system of claim 6, wherein the peripheral device is an ISA (Industry Standard Architecture) compliant peripheral device.
